(19) United States
(12) Patent Application Publication
(10) Pub. No.: US 2007/0204025 A1
(43) Pub. Date: Aug. 30, 2007

(54) Community Oriented Electronic Directory And Business Development System And Method

(76) Inventors: Edward A. Cox, Murrieta, CA (US); Joseph M. Rios, Murrietta, CA (US); Ralph R. Hartel, San Marcos, CA (US)

Correspondence Address: Merle W Richman;Richman & Associates, PO Box 3333, La Jolla, CA, 92038-3333, US

(21) Appl. No.: 11/547,528

(22) PCT Filed: Mar. 29, 2005
(86) PCT No.: PCT/US05/10537

§ 371 Date: Sep. 29, 2006

Related U.S. Application Data
(60) Provisional application No. 60/557,163, filed on Mar. 29, 2004.

(51) Int. Cl. G06F 15/173

(52) U.S. Cl. 709/223

(57) ABSTRACT

An interactive community oriented business directory system (40) and process that and a media encoded with instructions and data that, when executed, enables a customer to search for businesses located within a specific region where a data processing system (40) creates and maintains community oriented business directory databases and businesses may subscribe to or participate in one or more business packages where the business' exposure is increased in associated directory databases (42) via one or more program options. A customer may access the directory database via an interactive web page.

### CROSS REFERENCE TO RELATED APPLICATIONS

This invention is related to Provisional Patent Application No. 60/557,163, filed Mar. 29, 2004, Attorney Docket Number 3091.2.1P, and entitled “An Electronic Directory Search Interface” which is hereby incorporated by reference for its teachings.

### BACKGROUND

1. Field of the Invention

This invention relates to business directory systems and methods, and more particularly to interactive business directory systems and methods.

2. Description of Related Art

Prior art, hard copy business directories (such as a local telephone provider's yellow pages) include information about local businesses. The local telephone provider may offer businesses a variety of listing formats or packages where the business information included in the directory varies based on the selected/subscribed package. The business directory creator commonly charges subscription fees for such enhanced packages where the enhanced packages enable businesses to include additional information or distinctive listing features (such as color, size, or other printing options) to distinguish their services over similar businesses. It is desirable to enable a customer to interactively locate a nearby business. Accordingly, a need exists for an interactive business directory system and method that enables a user (thereof) to locate a business of interest in or about their community while enabling businesses to actively increase their market presence via the system or method.

### SUMMARY

The present invention includes an interactive community oriented business directory system, method for, and an encoded media including instructions that when executed by a device perform the acts enabling a business computer system to select at least one program option and provide data for the selected program option. The invention also generates a business directory database having information related to a group of businesses located within the geographical region and selected program options and related data via a directory computer system. The invention further enables a customer computer system to access the business directory database.

The invention may also enable the customer computer system to download the business directory database and software from the directory computer system via the Internet. The invention may enable the customer computer system to access the business directory database via an Internet web page hosted by the directory computer system. In addition, the invention may enable the business computer system to communicate with the directory computer system via an Internet web page. In an exemplary embodiment the business directory database includes a plurality of business categories and the database is searchable based on the plurality of business categories. In a further embodiment the invention may enable the database access software to provide a map window, a search window, and a search results window when executed on the customer computer system.

In another embodiment the invention may enable the database access software to maintain an event log table on the customer computer system. Further, the invention may enable a customer computer system user to select one of a category, keyword, and name search type in the search window. In an exemplary embodiment the selectable business options include providing a video link, driving directions to the business, map icons shown on the map window when the business is located during a search, detailed business description, multiple searchable keywords, electronic coupons, listing in multiple categories, one or more web-links, and one or more E-mail links.

The present invention may also award customers operating the database software or accessing the database via a web page points for predetermined activity. In this embodiment, the customer may be given access to coupons requiring differing activity point levels. In one embodiment the required level for certain coupons may be displayed. In another embodiment the coupons requiring activity point levels may only be displayed when the customer has the required activity point level.

In one embodiment a business may update their selected business options via an interactive web page provided by the directory computer system. In another embodiment a business may update their selected business options offline and then transmit the updated options to the directory computer system via the internet. In another embodiment the directory includes community information.

In a further embodiment, customer computer system user activity when accessing the business directory is stored in an event log table. In this embodiment, the user event log table may be periodically, after a predetermined number of events have been recorded, or after a predetermined time period has lapsed since the last synchronization, the event table log may transmitted to the directory computer system during a synchronization process. In this embodiment during the synchronization the business directory may be updated based on the business directory version currently being accessed by the customer computer system and the current business directory version. During such synchronization the event table log is ideally cleared.

In an exemplary embodiment a business may request a customer activity report that is compiled by the database computer system from uploaded customer computer system event table logs. In an exemplary embodiment the business may tailor the activity report based on geographical parameters, category selection(s), keyword selection(s), activity time frame, and search filter(s). In another embodiment, the customer may enter their geographical region or the region may be determined via GPS signals or other location technology by the CCS 12, 14 and transmitted to the COIBDS 40.

In another embodiment the map window may be automatically centered on the customer computer system user's address where this location is indicated by a house-shaped icon. In this embodiment, participating businesses displayed in the search window may have a location icon in the map window. In another embodiment, some business may have unique icons or icons similar to their known trademarks.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a block diagram of exemplary community oriented interactive business directory architecture 10 in accordance with the present invention.

FIG. 2 is a block diagram of an exemplary community oriented interactive business directory processing system 40 as shown in FIG. 1.

FIG. 3 is a flowchart of an exemplary community oriented business directory database generation process in accordance with the present invention.

FIG. 4 is a flowchart of an exemplary web based community oriented interactive business directory database selection and download process in accordance with the present invention.

FIG. 5 is a flowchart of an exemplary community oriented interactive business directory database loading process in accordance with the present invention.

FIG. 6 is a flowchart of an exemplary community oriented interactive business directory customer installation process in accordance with the present invention.

FIG. 7 is a flowchart of an exemplary community oriented interactive business directory software database installation process in accordance with the present invention.

FIG. 8 is a flowchart of an exemplary community oriented interactive business directory business association process in accordance with the present invention.

FIG. 9 is a flowchart of an exemplary community oriented interactive business directory business information setup or maintenance process in accordance with the present invention.

FIG. 10 is a flowchart of an exemplary community oriented interactive business directory customer activity report request process in accordance with the present invention.

FIG. 11 is a flowchart of an exemplary community oriented interactive business directory customer activity report generation process in accordance with the present invention.

FIG. 12A is a flowchart of an exemplary community oriented interactive business directory software startup process in accordance with the present invention.

FIG. 12B is a flowchart of an exemplary web-based community oriented interactive business directory process in accordance with the present invention.

FIG. 13 is an illustration of an exemplary community oriented interactive business directory screen in accordance with the present invention.

FIG. 14 is an illustration of an exemplary community oriented interactive business directory screen where businesses are searchable based on one or more categories in accordance with the present invention.

FIG. 15 is an illustration of an exemplary community oriented interactive business directory screen including search results in accordance with the present invention.

FIG. 16 is an illustration of an exemplary community oriented interactive business directory screen where a business shown in the search results is highlighted when a corresponding map icon is selected in accordance with the present invention.

FIG. 17 is an illustration of an exemplary community oriented interactive business directory screen having a map location icon highlighted due to the selection of a business in the search results having a store at the map location in accordance with the present invention.

FIG. 18 is an illustration of an exemplary community oriented interactive business directory screen having basic business information displayed due to the selection of the business in the search results in accordance with the present invention.

FIG. 19 is an illustration of an exemplary community oriented interactive business directory screen having enhanced business information displayed due to the selection of the business in the search results in accordance with the present invention.

FIG. 20 is an illustration of an exemplary community oriented interactive business directory screen having premium business information displayed due to the selection of the business in the search results in accordance with the present invention.

FIG. 21 is an illustration of an exemplary community oriented interactive business directory screen having video content displayed due to the selection of the video link in the premium business information table shown in FIG. 20.

FIG. 22 is an illustration of an exemplary community oriented interactive business directory screen having a business coupon table displayed in accordance with the present invention.

FIG. 23 is an illustration of an exemplary community oriented interactive business directory screen having a featured business table displayed in accordance with the present invention.

FIG. 24 is an illustration of an exemplary community oriented interactive business directory screen having community information displayed in accordance with the present invention.

### DETAILED DESCRIPTION

Throughout this description, embodiments and variations are described for the purpose of illustrating uses and implementations of the invention. The illustrative description should be understood as presenting examples of the invention (termed exemplary embodiments), rather than as limiting the scope of the invention.

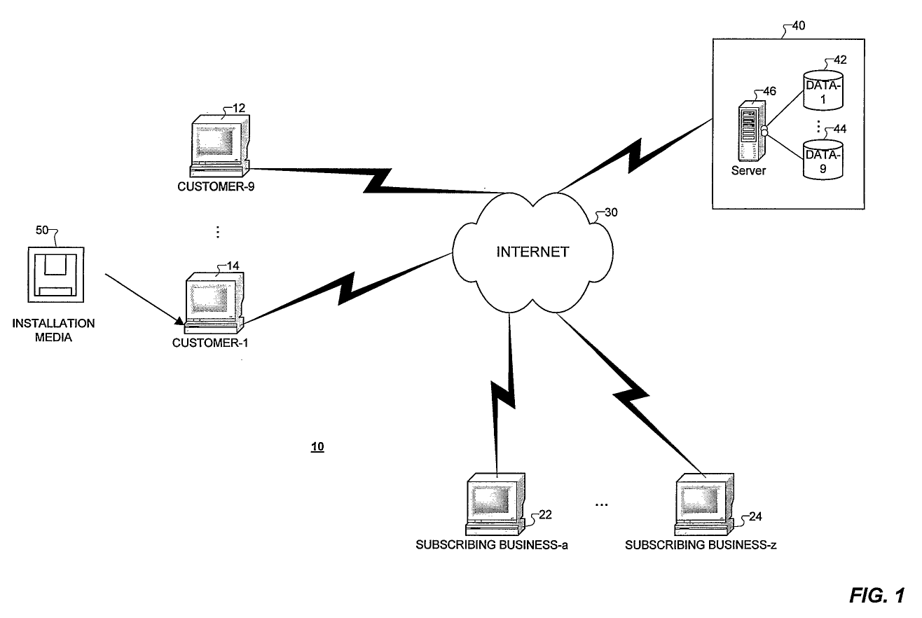

FIG. 1 is a block diagram of exemplary community oriented interactive business directory architecture 10 according to the present invention. Exemplary architecture 10 includes a plurality of customer computer systems (“CCS”) 12, 14 and a plurality of subscribing or participating business's computer systems (“SBS”) 22, 24 coupled to an exemplary community oriented interactive business directory data processing system (“COIBDS”) 40 via a network of networks or Internet 30. In one exemplary embodiment a business representative may select a business' directory subscription and maintain their business information via a SBS 22, 24 that receives one or more web pages generated and provided by the COIBDS 40. The exemplary COIBDS 40 may generate and provide web pages via the Internet 30 that enable a business representative to subscribe to their directory service and maintain their business information associated with selected subscription. The COIBDS 40 may store the business information in one or more databases.

In one exemplary embodiment, a customer via a CCS 12, 14 may download interactive software and community oriented business information formatted into a database to be accessed by the interactive software from the COIBDS 40 via the Internet 30. In another exemplary embodiment the directory provider may generate and distribute computer readable media 50 including the interactive software and community oriented business information formatted into a database to be accessed by the interactive software. The installation media 50 may be any non-violate computer readable media including compact disc (“CD”) or memory card (such as compact flash (“CF”) or secure digital (“SD”) card). In another embodiment a customer via a CCS 12, 14 may interactively view community oriented business directory information via a web page provided by the COIBDS 40 via the Internet 30. The CCS 12, 14 and SBS 22, 24 may be any device capable of executing a software program including a computer (having a processor and some non-violate storage medium and an operating system such as Microsoft® Windows®, Linux®, Unix®, Mac® OS 9 or OS X®, for example), personal data assistant (“PDA”), or cellular telephone including some software execution system (such as Microsoft's® Smartphone® 30 operating system and Qualcomm's® BREW® operating system, for example). In one exemplary embodiment a CCS 12, 14 user may execute the downloaded or installed business directory software locally (no real time interaction with the COIBDS 40) to search for a desired business in or about their community. In another exemplary embodiment, a CCS 12, 14 user may search for a desired business in or about their community via a web page generated by the COIBDS 40 (real time interaction).

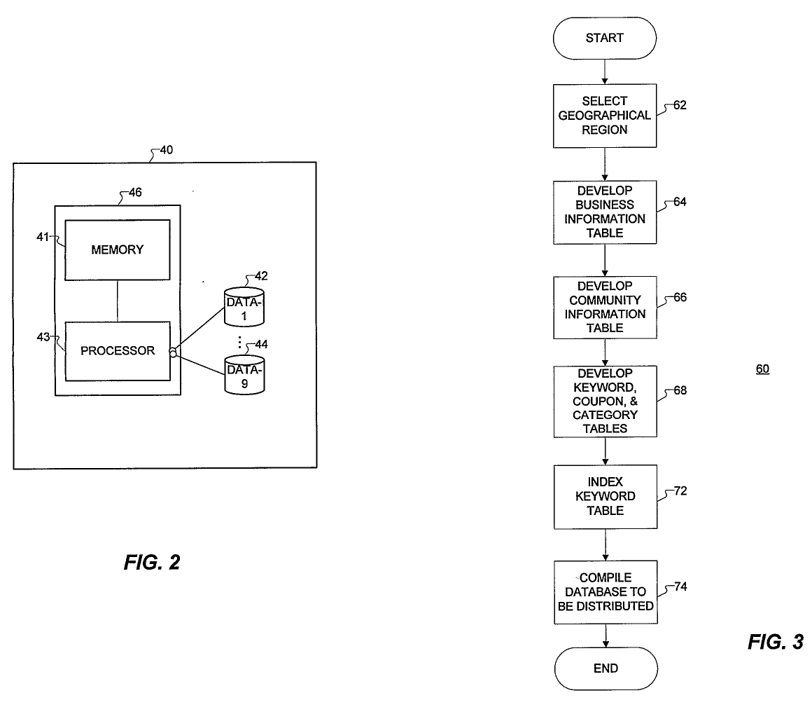

FIG. 2 is a block diagram of an exemplary COIBDS 40 as shown in FIG. 1. The COIBDS 40 includes a server 46 and a plurality of data storage devices 42, 44 such as optical, magnetic, or other permanent data storage devices. The COIBDS 40 stores databases on the storage devices 42, 44 where the databases are used to maintain and generate community specific business directories. The COIBDS 40 may also store program files on the storage devices 42, 44 where the program files include executable instructions for updating and generating updated community oriented databases and customer or business user web pages. The COIBDS 40 server 46 includes a memory 41 coupled to a processor 43 where the processor is also coupled to the storage devices 42, 44. The processor 43 executes program instructions for processing performing customer synchronization, update database, and processing subscription requests from businesses for the SBS 22, 24 and CCS 12, 14. The memory 41 stores data and program instructions where the data may include processing synchronization data, database updates, and business subscription requests that may be stored in a database on a storage device 42, 44. The COIBDS 40 may execute a Microsoft® .Net® program and enable communication between itself and the CCS 12, 14 and SBS 22, 24 via an extensible Markup Language (“XML”).

FIG. 3 is a flowchart of an exemplary community oriented business directory database generation process 60 in accordance with the present invention. In the process 60 an exemplary community oriented business directory database is generated for distribution to a CCS 12, 14 via Internet 30 transfer or installation media 50 or use by a CCS 12, 14 real-time via a web-page. In the process 60, the geographical region (community orientation) is first selected or established, step 62. A CCS 12, 14 user installation request, synchronization request, or web-page interaction request may include an indication of the user's geographical location such a postal zip code, city and state, telephone area code and exchange, or other geographical identifier. In one embodiment the CCS 12, 14 may indicate its current location via one or more Global Positioning System (“GPS”) signals or cellular based location signals. Based on the geographical identifier, the COIBDS 40 may select businesses located near or about the identified geographical location and prepare a business list table. In an exemplary embodiment, the business list table may include additional information to be displayed where the associated business has a subscription where detailed business information is displayable. In the exemplary process 60 a community information table may be populated or generated based upon the identified geographical location, step 66. The community information table may include local government information, demographics, weather reports/data, regional recreational information, public and private school information, emergency and other important contact information including telephone numbers, web page addresses, links, and associated electronic mail addresses, and private and public utility information.

The exemplary database generation process 60 may generate or populate a keyword, coupon, and category tables where a limited number of keywords, electronic coupons, and business categories may be associated with each business listed in the business table, step 68. In an exemplary embodiment a business may be allocated a limited number of assignable keywords, coupons, and business categories based on their selected subscription. In one exemplary embodiment, a non-subscribing business may not be allocated any keywords or coupons and included in only one business category and subscribing/participating businesses may be allocated a range of keywords, coupons, and be included in a plurality of business categories depending on their subscription type or participation level (20, 50, or 100 keywords, 1, 3, or 6 electronic coupons, and 1 or 2 business categories in one embodiment). Each keyword may be unique or a business may repeat a keyword to increase the number of hits found in a search depending on the business's primary function. In an embodiment a business may create electronic coupons where each coupon may include a description and an expiration date. A customer using the software included with the database may view and print the coupons to obtain the discounts or offers detailed in each coupon upon representation to the associated business prior to the expiration date.

In another embodiment a salesperson may be responsible for selecting a business's keywords, preparing their coupons, and selecting their categories, and other information to ensure that the business is properly indexed and categorized to prevent customer frustration/confusion. In another embodiment the process 60 may also prepare a keyword index table (step 72) to reduce keyword searching time and complexity. The resultant database including the business information, community, keyword, category, keyword index, and coupon tables may be then distributed to/or viewable by customers in corresponding identified geographical locations via the Internet 30 or an installation media including the database and supporting software.

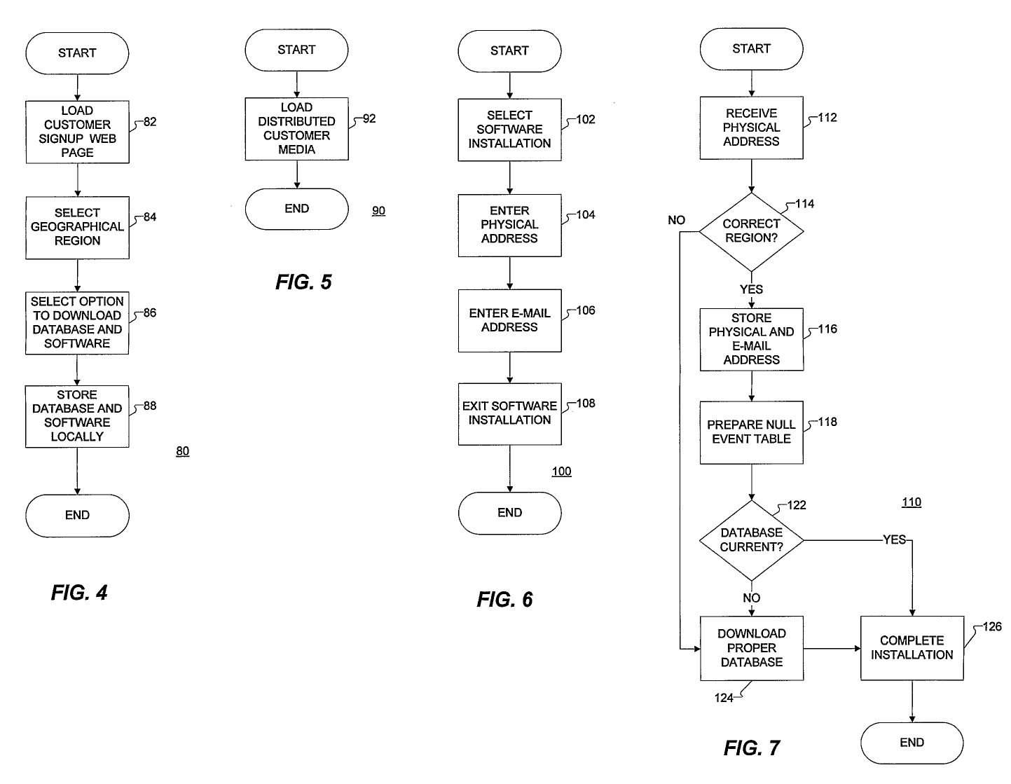

FIG. 4 is a flowchart of an exemplary web based community oriented interactive business directory database selection and customer download process 80 in accordance with the present invention. In the download process 80, a customer via a CCS 12, 14 may first load a business directory download web page, step 82. The COIBDS 40 may generate the web page or process to the web page request or another web page provider controlled by the COIBDS 40 may transmit the customer directory download web page to the requesting CCS 12, 14. The customer may then select or indicate their geographical location (step 84). The COIBDS 40 via process 60 may then generate the appropriate community oriented database. The customer via a CCS 12, 14 may then elect to download the compiled database and associated software (step 86). The software version may be determined by the request type (internet browser type) or may be platform independent object code, such as visual basic object code that may be executed on any .Net® platform. The downloaded database and associated business directory software may be stored locally (step 80) on a CCS 12, 14 until the software is installed.

FIG. 5 is a flowchart of an exemplary community oriented interactive business directory database and software loading process 90 in accordance with the present invention. In this process, a customer has received installation media 50 including a geographically oriented database and associated business directory software. The customer uses a CCS 12, 14 to read the media 50 (step 92). After completion of process 80 or 90, a customer may install the business directory software on a CCS 12, 14. FIG. 6 is a flowchart of an exemplary community oriented interactive business directory customer installation process 100 in accordance with the present invention. In this process 100, a customer starts the software installation process (step 102). In an exemplary installation process the customer is required to enter their physical address and an electronic mail (“E-mail”) address (steps 104 and 106). The software is then installed (process 110 shown in FIG. 7 is executed in an exemplary embodiment). The business directory software and database installation process 100 is then exited (step 108).

As noted, FIG. 7 is a flowchart of an exemplary community oriented interactive business directory software installation process 110 performed by the CCS 12, 14 in accordance with the present invention. In the process 110, the physical address is received along with the database version (step 112). The geographical region is determined based on the physical address and compared to the database region encoded in the database version (step 114). When the geographical region and database region match, the customer's physical and E-mail address are stored in one or more tables within the business directory database (step 116). The process 110 then prepares a null event table (step 118) where certain customer activities such as searches, search terms, category selection, keyword entry, and filter activation may be stored in the event table and the event table may be uploaded to the COIBDS 40 during synchronization. In an exemplary embodiment, a customer is assigned points (term coupoints) for recorded event activity. These points are also accumulated in the event table and may be uploaded to the COIBDS 40 during synchronization. In a further exemplary embodiment, certain businesses may/create coupons that are only displayed/available to customers having a certain coupoint total. In one exemplary embodiment the required coupoint level to display certain coupons is not shown whereas in other embodiments the required level and current level are displayed so a customer has an incentive to use the business directory software.

The exemplary customer-side business directory software installation process 110 may determine whether stored business database is current (step 122). The software may determine the database creation date based on the database version. The software may communicate with COIBDS 40 to determine the latest database version available for the geographical region When the process 110 determines that the database is not current—out-dated, the software may request and receive the latest database version from the COIBDS 40, step 124 (where the COIBDS 40 may perform process 60 shown in FIG. 3 to generate the latest database). The customer-side business directory software installation process 110 is then complete (step 126).

FIG. 8 is a flowchart of an exemplary community oriented interactive business directory business subscription or participation process 130 in accordance with the present invention. In this exemplary process 130, a business that wants to be included in the business directory database may elect to participate in or subscribe to one or more business packages where each package offers different levels of business exposure. In the exemplary process 130 a business representative may first load a business partner subscription/participation signup web page (step 132). The SBS 22, 24 may generate a web page request that is received and returned with the subscription election/participation level page by the COIBDS 40 via the Internet 30. The business representative may then elect the desired subscription or participation package via the web page provided by the COIBDS 40 (step 134). The business representative may then be required to enter their business's physical address and one or more E-mails addresses to be associated with the business (step 136). The business representative may then elect a payment program or option to enable the elected subscription or participation package (step 13 8). In the exemplary process 130, the business representative's entries may be stored in a local table (on the SBS).

FIG. 9 is a flowchart of an exemplary community oriented interactive business directory business information setup or maintenance process 150 in accordance with the present invention. After a business has enabled a subscription package or any time during their subscription, a business may enter or modify their business information that is included in one or more business directories based on their geographical location/region and subscription type by loading a maintenance web page from the COIBDS 40 via the Internet (step 152). In one embodiment this process may be performed locally on a SBS 22, 24 and uploaded to the COIBDS 40 at a later time. A business representative may edit the business information and links to be shown on a business information window based on their subscription package (step 154). The business information may include one or more web links, video link, and detailed information to be associated with the business. The business representative may also modify or select keywords, categories, and coupons to be associated with the business where the number of each is determined by their subscription package (step 158). The business representative may also enter one or more E-mail addresses to be associated with the business (step 162). In an exemplary embodiment, the information in the business window may comprise an electronic business information window that the customer-side business directory software or web page active program automatically uploads to one or more address books (such as Outlook® address book, cellular phone address book, or PDA address book) upon selection of the business's information card.

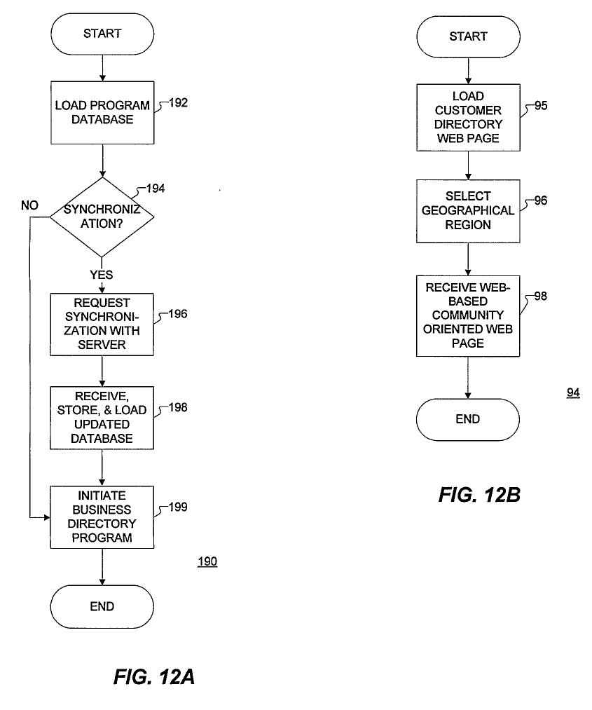

In an exemplary embodiment, the business representative may also be able to upload a digitally encoded video (of any known format, such as motion pictures expert group (“MPEG”)) (step 164) to be displayed within the customer-side business software upon its selection. The ability to upload and display videos to customers may depend upon the business elected subscription package. As noted above when a customer is using the community oriented interactive business directory software their actions may be recorded as events, stored in a local (on a CCS 12, 14) table, and uploaded to the COIBDS 40 during synchronization operations (process 190 shown in FIG. 12). A subscribing business or other business entities may be able to request and receive various customer activity reports based on events data collected from one or more customers during synchronization operations with the COIBDS 40.

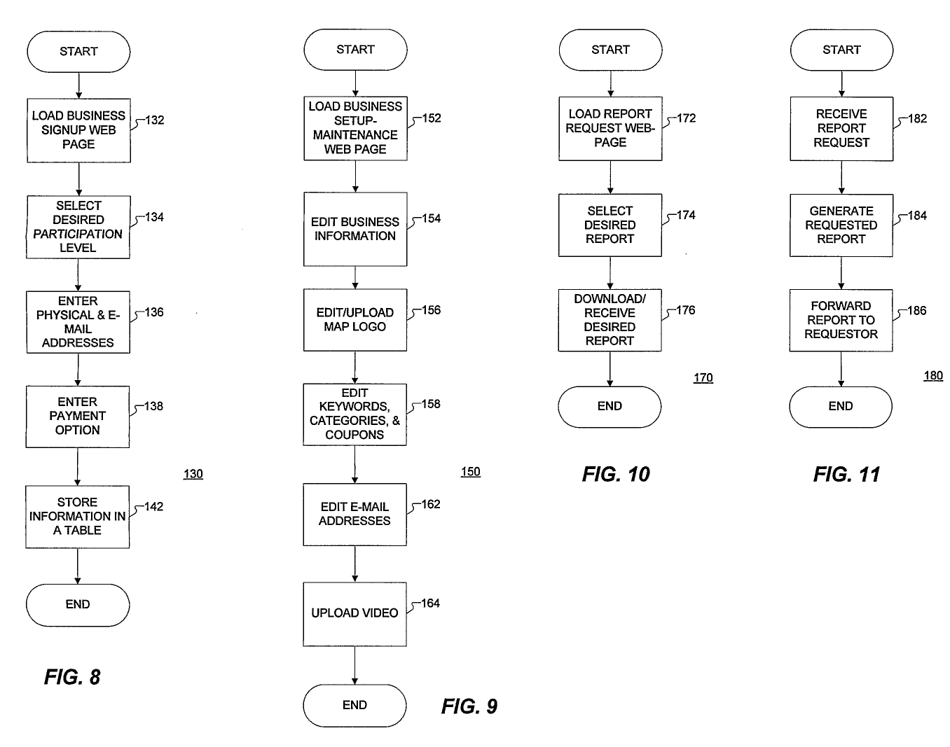

FIG. 10 is a flowchart of an exemplary community oriented interactive business directory customer activity report request process 170 in accordance with the present invention. An individual or business that wants a customer activity report may load a customer activity report request web page from the COIBDS 40 (step 172). The user may then select the desired report (step 174) and download or receive the desired customer activity report (step 176). FIG. 11 is a flowchart of an exemplary community oriented interactive business directory customer activity report generation process in accordance with the present invention. When the COIBDS 40 receives a customer activity report request (step 182), the COIBDS 40 may generate the selected report based on event data accumulated during synchronization operations between a CCS 12, 14 and COIBDS 40. The report selection may include geographical parameters, category selection(s), keyword selection(s), activity time frame, and filter(s) employed in one exemplary embodiment. Upon generation of the report, the COIBDS 40 may forward the report to the requestor via the Internet 30 (step 180).

FIG. 12A is a flowchart of an exemplary community oriented interactive business directory customer-side software startup process 190 in accordance with the present invention. In the exemplary process 190, a business directory database is loaded. In one exemplary embodiment, the process 190 may prompt the user whether they would like to synchronize the business directory database periodically, when a predetermined number of events have been recorded, or a predetermined time frame has passed since the last synchronization. The program may remind the user that they have uncollected coupoints that will be collected upon synchronization to encourage frequent synchronization. In another exemplary embodiment the process may automatically synchronize the business directory database periodically, when a predetermined number of events have been recorded, or when a predetermined time frame has passed since the last synchronization (step 194). When the user requests synchronization or the process 190 automatically activates synchronization, the process 190 requests synchronization with the COIBDS (step 196). The COIBDS 40 may receive the event log table from the CCS 12, 14 and transmit the latest business directory database with a null event log table. The process 190 may receive, store, and load the updated business directory database upon receipt (step 198). The process 190 may then initiate or start the community oriented interactive business directory program.

In another embodiment a customer may interactively obtain community oriented business information via a web page provided, real-time by the COIBDS 40. FIG. 12B is a flowchart of an exemplary process 94 that enables a customer to interactively obtain community oriented business information via a web page provided by the COIBDS 40. In the process 94, a customer loads a customer business directory web page, step 95. In the process 94, the customer may login or automatically be logged so their coupoints may be accumulated based on their activity. In another embodiment, the customer may enter their geographical region or the region may be determined via GPS signals or other location technology by the CCS 12, 14 and transmitted to the COIBDS 40, step 96. The process 94 may then provide a region specific interactive business directory web page, step 98. The customer may then select options provided on the web page to find one or more regionally business of interest. The customer's activity may be stored in an event table log stored in a database on the COIBDS 40.

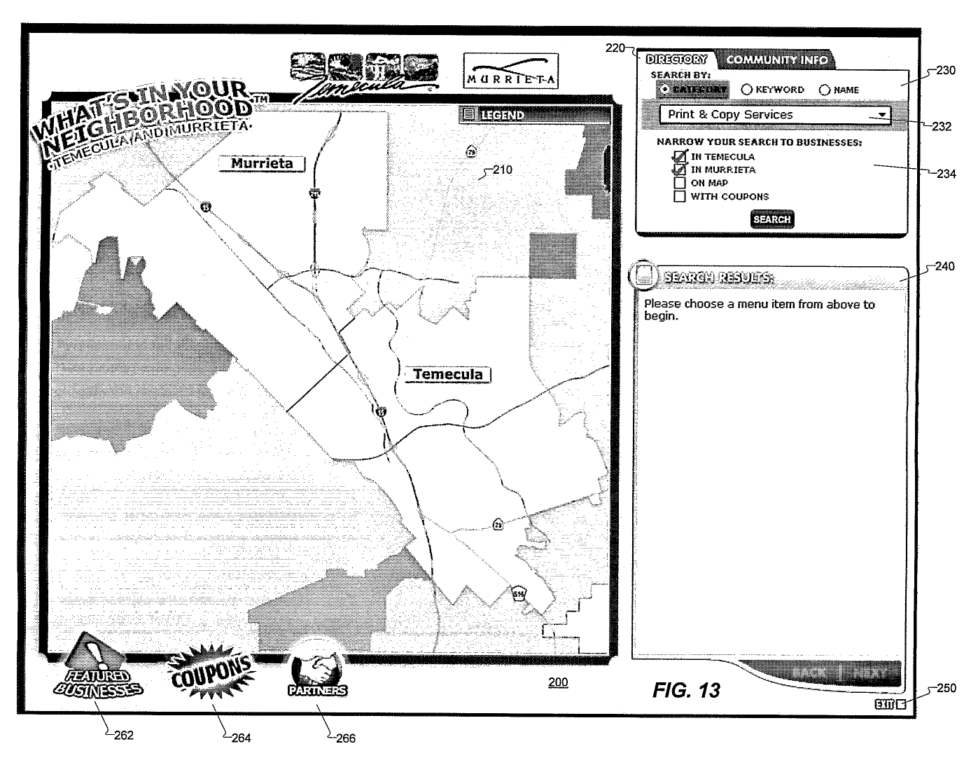

FIG. 13 is an illustration of an exemplary community oriented interactive business directory program screen or web page 200 in accordance with the present invention. As shown in this figure, the screen or web page 200 includes a map section 210, a search selection section 220, and a search result section 240. The exemplary screen 200 also includes several hot buttons 262, 264, and 266. In the exemplary map section 210 the geographical region includes two communities, Murrieta, Calif. and Temecula, Calif. Depending on the community size or density the map section 210 may include more than one community or only a segment of a single community. In addition, a customer may zoom into a region of the map section 210. In another exemplary embodiment of the invention the map section 210 is centered about the customer's physical address, which may be depicted with a house-shaped icon (not shown).

The hot buttons 262, 264, and 266 include links to featured businesses, business coupons, and partners located within the geographical region shown in map section 210. A customer may exit the directory program by selecting the exit button 250. Upon exit, the directory program or web page may note the program execution time in the event log table.

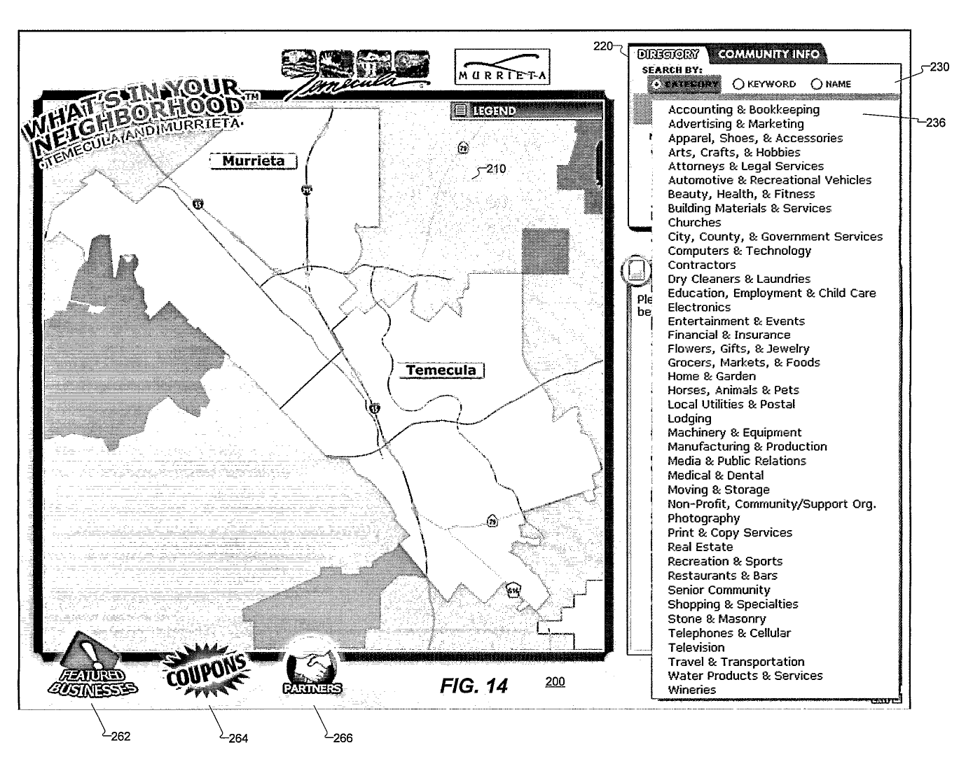

In the exemplary embodiment 200, the search selection section 220 includes multiple tabs, a business directory tab and community information tab, search type selection 230 (category, keyword, or name in an exemplary embodiment), search term entry or pull-down area 232 (varies as a function of search type, e.g., when the search type selected is category, the search term entry 232 may be a limited list such as the exemplary category list 236 show in FIG. 14). The search selection section also includes one or more selectable filters 234. In the exemplary embodiment the search filters include geographical limitations (business located within a specific region or city), businesses that have a display map location (featured business in one exemplary embodiment), or businesses that offer have at least one electronic coupon.

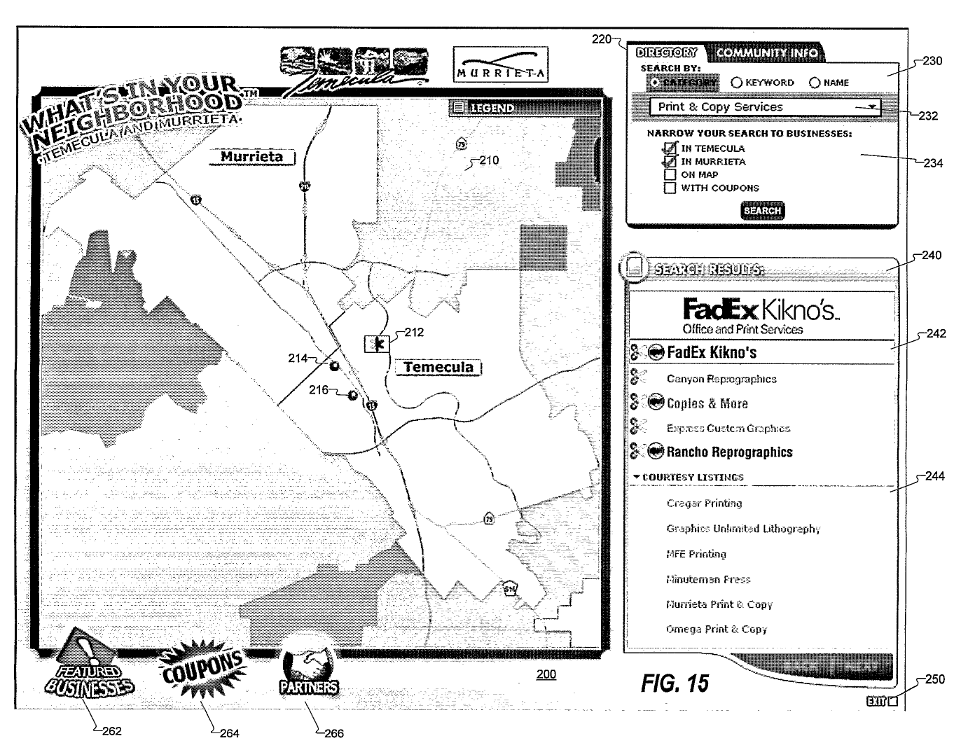

FIG. 15 is an illustration of an exemplary community oriented interactive business directory screen including search results 240 based on the search selection section 220 in accordance with the present invention. The search selection section 220 parameters may be stored in the event log table each time a search is requested. In FIG. 15 the search result section 240 is divided in several subsections 242 and 244 where section 242 shows participating business (having a subscription package in an exemplary embodiment) and subsection 244 lists courtesy businesses. In the participating business section 242 the exemplary embodiment includes several icons to indicate business options, for example, a sissor-icon to indicate that the business has at least electronic coupon, and a blue button next to the business name to indicate that the business has a corresponding icon in the map section 210. In the exemplary search results shown in FIG. 15, all the participating businesses offer electronic coupons and three of the five participating businesses have corresponding map icons 212, 214, and 216. As shown in the map section 210 a business may have a unique or trademark related map icon 212 or a generic map icon 214 or 216.

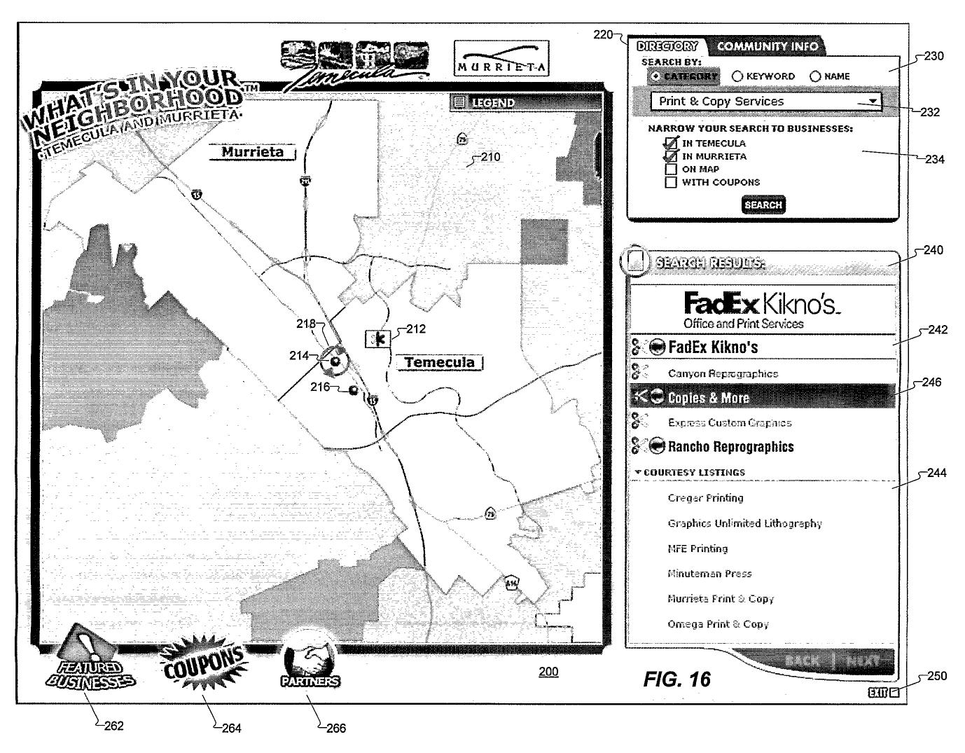

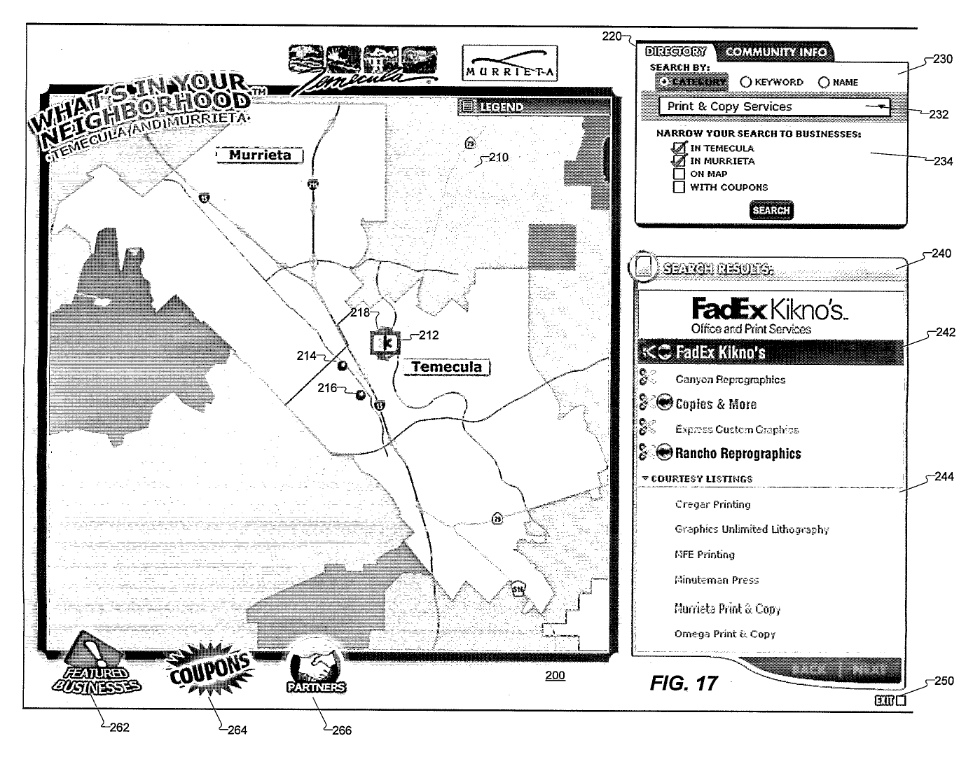

As shown in FIGS. 16 and 17 when either a map icon 212, 214, 216 is traversed by a mouse or cursor in the map section 210 or a corresponding business listing in the search result section 240 is traversed by a mouse or cursor, the pair are highlighted. In particular as shown in FIG. 16, when the map icon 214 is traversed in the map section 210, the corresponding map icon is highlighted by a spinning circle 218 having the map icon 214 as its center. The corresponding business name 246 is highlighted in the search result section 240. Further, as shown in FIG. 17, when the business name is traversed in the search results section 240, the corresponding map icon 212 is highlighted by a spinning circle 218 having the map icon 212 as its center. In an exemplary embodiment, when a customer double clicks a map icon 212, 214, or 216, detailed driving directions are displayed from the customer's physical address to the selected business corresponding to the map icon. In another exemplary embodiment, reverse directions may also be displayed where either direction set may be printed or stored for use as driving directions.

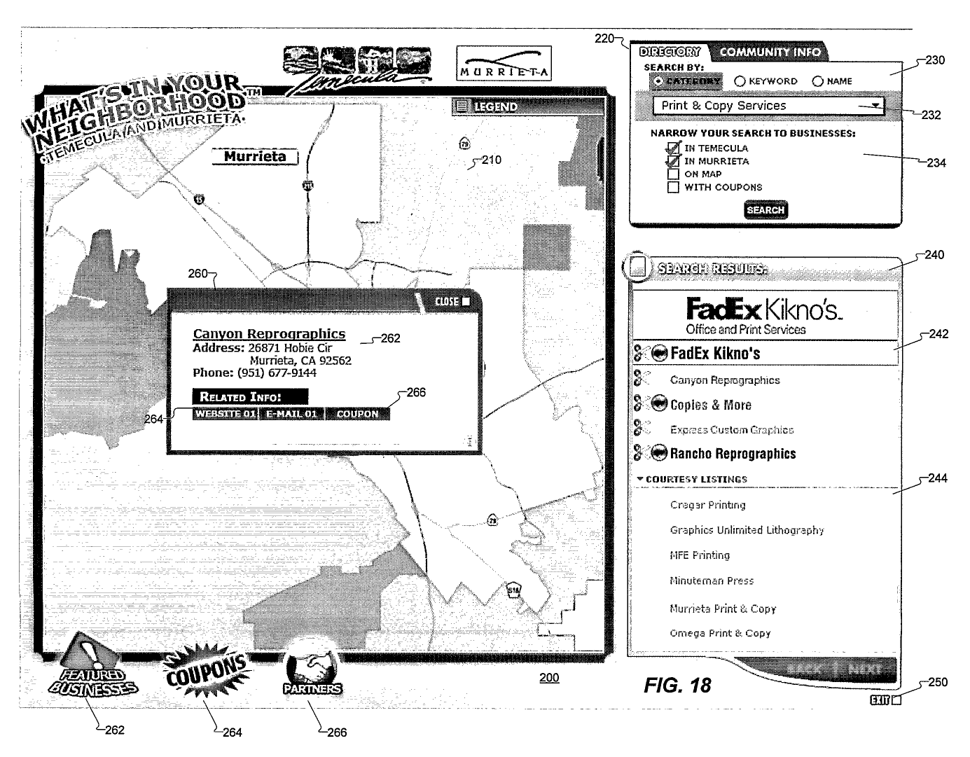

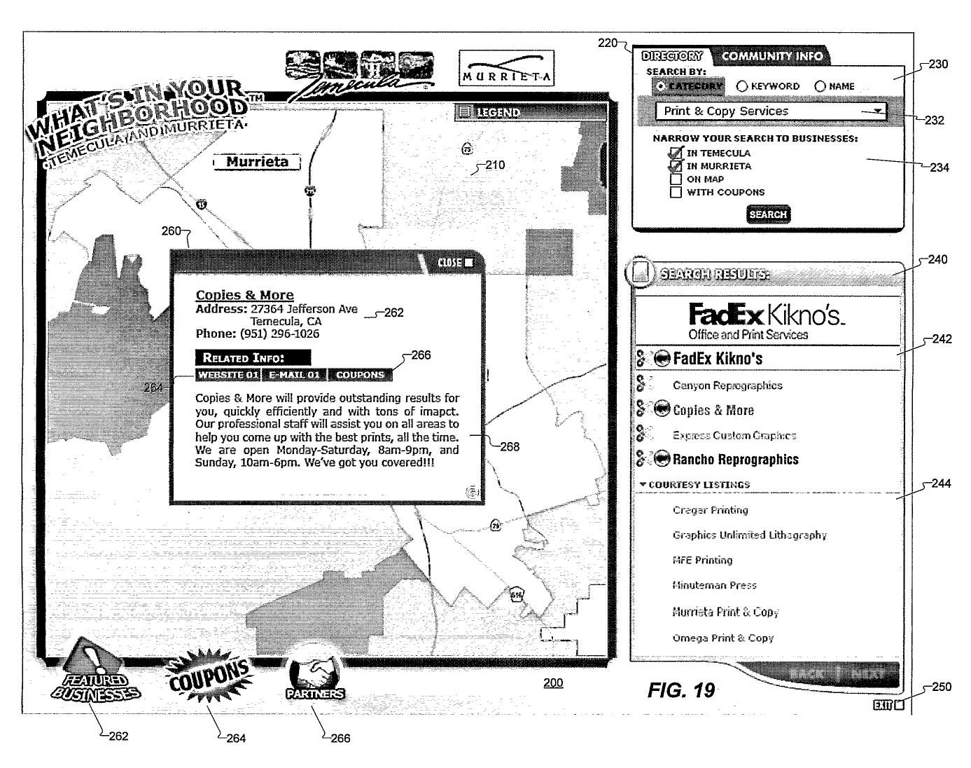

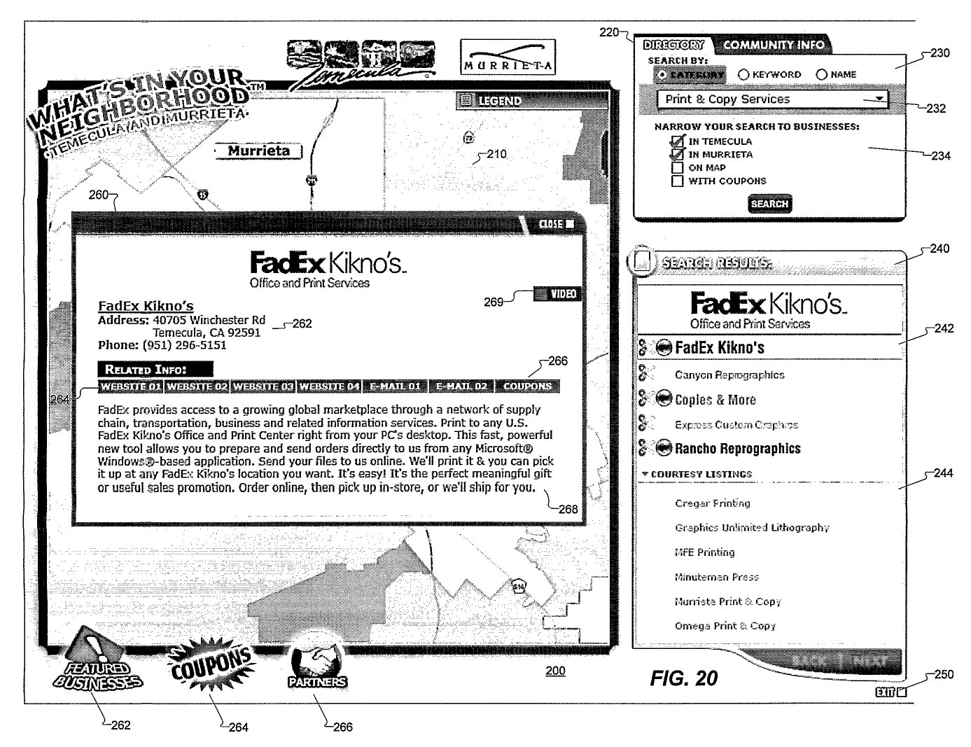

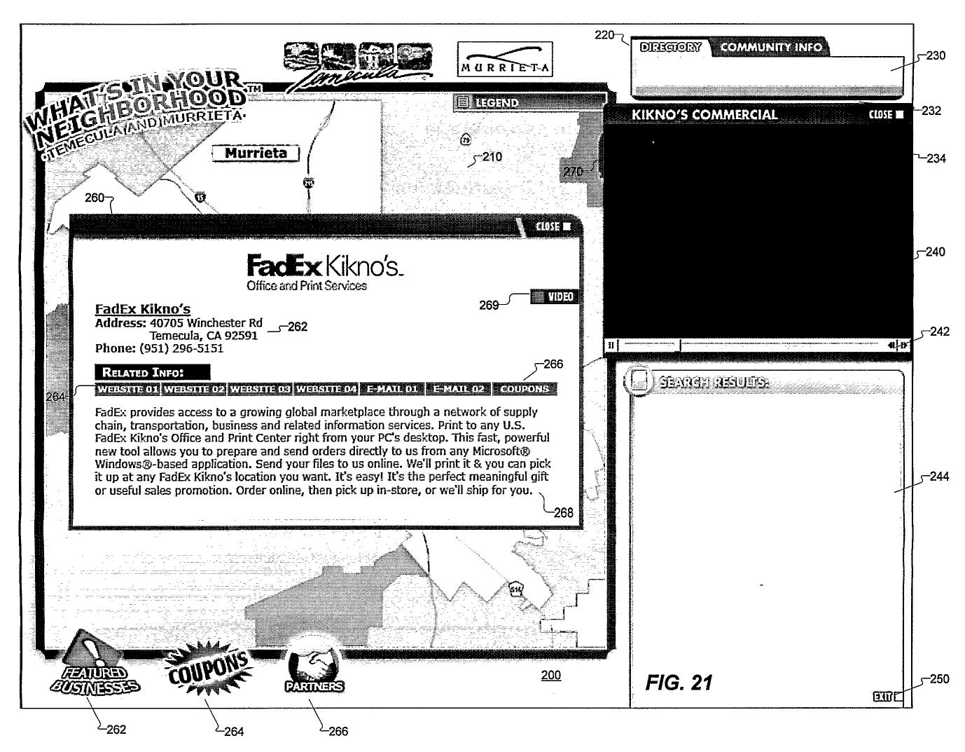

FIGS. 18, 19, and 20 show three different business information windows 260 that are generated when a participating business 242 is selected in the search result section 240. The business information window 260 shown in FIG. 18 includes the business's physical address and telephone number 262, website and E-mail links 264 and electronic coupon link 266. In an embodiment the information window 260 may also include a driving direction link that displays driving directions between the business and customer address when selected. In an exemplary embodiment when a business information window 260 is displayed the contact information is also automatically downloaded to a local business address. The business information window 260 shown in FIG. 19 further includes a detailed description of the business 268. The business information window 260 shown in FIG. 20 additionally includes a video playback button 269 where the video content is shown in a video window section 270 such as the exemplary video window section 270 shown in FIG. 21.

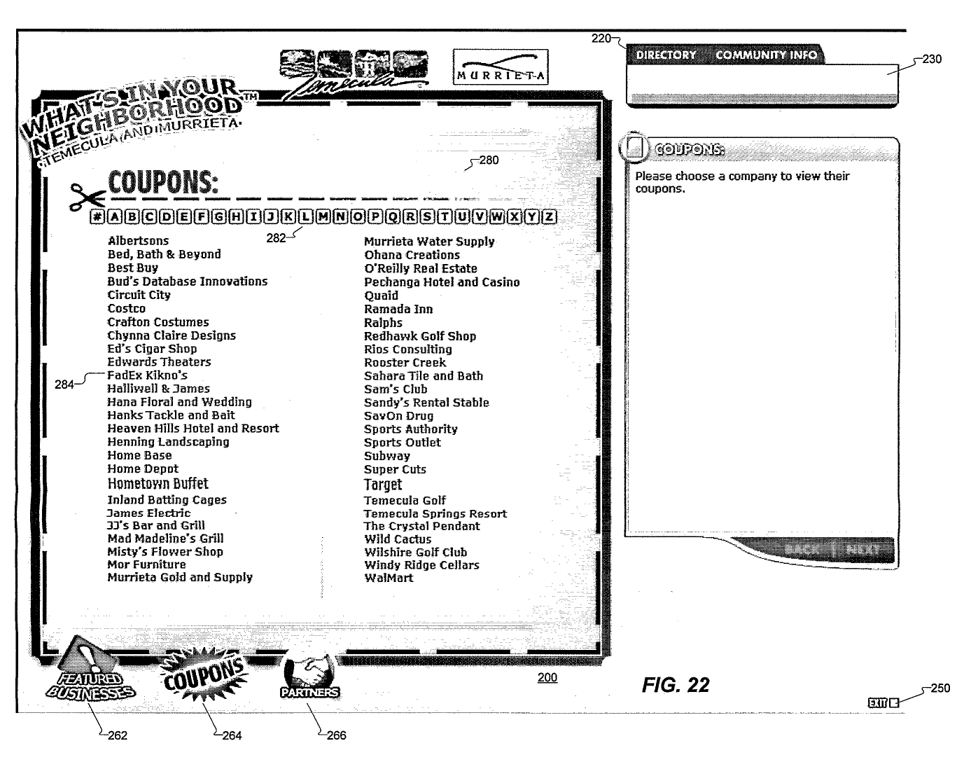

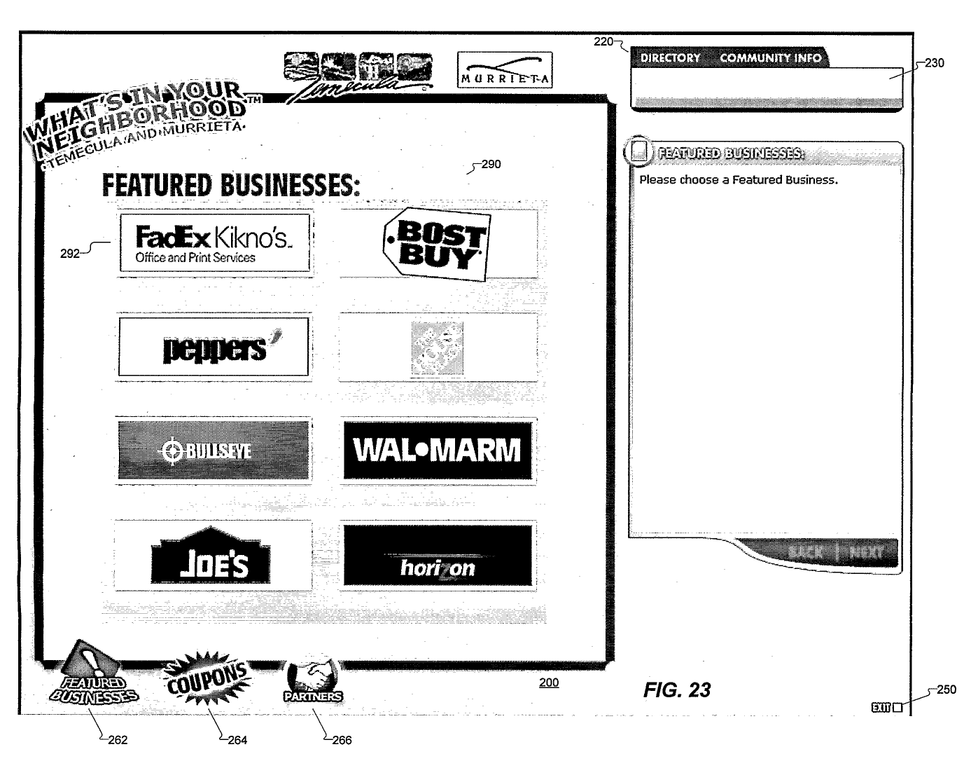

FIG. 22 shows a coupon window 280 that may be displayed when the coupon hot button 264 is selected in an embodiment. The coupon window or section 280 includes an alphabetical selection bar 282 and a listing of businesses offering coupons within the geographical region shown in the map section 210 or within anywhere within the geographical region captured by the database table in another embodiment. FIG. 23 shows a featured business window 290 that may be displayed when the featured business hot button 262 is selected in an exemplary embodiment. The featured business window or section 290 includes a graphical list of featured businesses 292 that are located within the geographical region shown in the map section 210 or within anywhere within the geographical region captured by the database table in another embodiment.

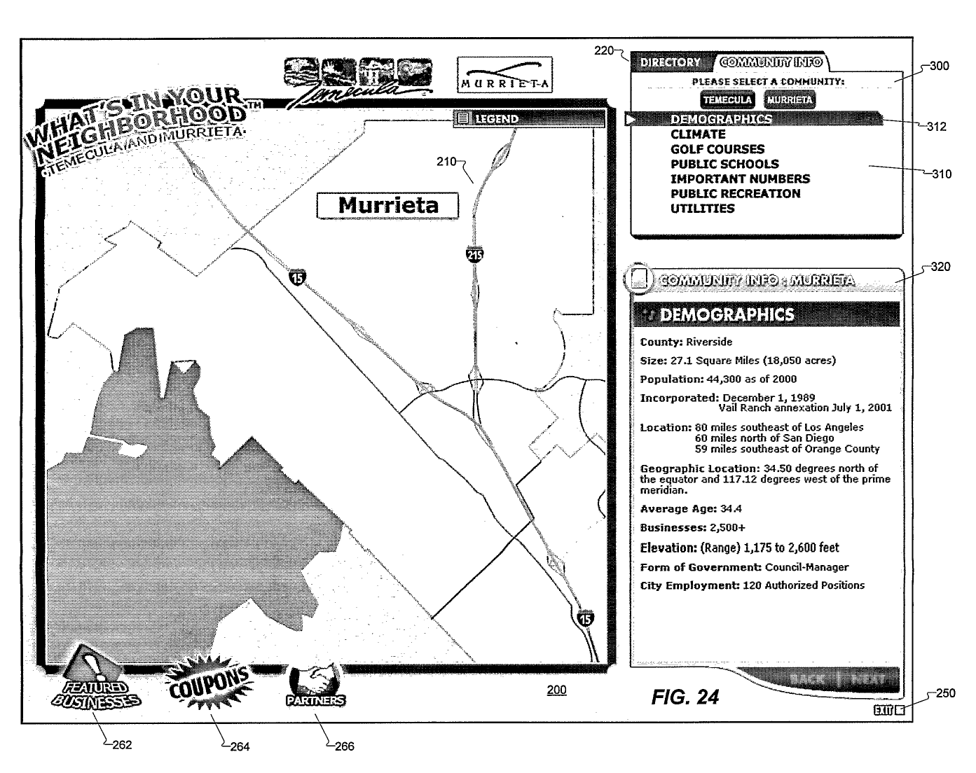

In an exemplary embodiment, the business directory program may provide information about the associated community or communities, as applicable. FIG. 24 illustrates an exemplary community information search section 300 and search results section 320. As shown in this example, the customer may select the community 312 and one or more categories 310. The search results 320 provide community information based on the selected search criteria and may include links to associated web pages.

While this invention has been described in terms of a best mode for achieving this invention's objectives, it will be appreciated by those skilled in the art that variations may be accomplished in view of these teachings without deviating from the spirit or scope of the present invention. For example, the present invention may be implemented using any combination of computer programming software, firmware or hardware (e.g., a software language, such as C++ or others may be used to implement the invention). As a preparatory step to practicing the invention or constructing an apparatus according to the invention, the computer programming code (whether software or firmware) according t-o the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code on a network for remote execution.

What is claimed is:

1. An interactive community oriented business directory system, comprising:
a customer computer system, the customer computer system associated with a geographical region;
a business computer system, the business computer system capable of communicating wits the directory computer system to select at least one program option and provide data for the selected program option;
a directory computer system, the directory system capable of generating a business directory database having information related to a plurality of businesses located within the geographical region including selected program options and related data; and
wherein the customer computer system has access to the business directory database.

2. The interactive community oriented business directory system of claim 1, wherein the customer computer system downloads the business directory database and software executable by the customer computer system to access the business directory database from the directory computer system via the Internet.

3. The interactive community oriented business directory system of claim 1, wherein the customer computer system accesses the business directory database via an Internet web page hosted by the directory computer system.

4. The interactive community oriented business directory system of claim 2, wherein the business computer system communicates with the directory computer system via an Internet web page.

5. The interactive community oriented business directory system of claim 4, wherein the business directory database includes a plurality of business categories and the database is searchable based on the plurality of business categories.

6. The interactive community oriented business directory system of claim 4, wherein the database access software provides a map window, a search window, and a search results window when executed on the customer computer system.

7. The interactive community oriented business directory system of claim 6, wherein the database access software maintains an event log table on the customer computer system.

8. The interactive community oriented business directory system of claim 6, wherein the search window enables a customer computer system user to select one of a category, keyword, and name search type.

9. An interactive community oriented business directory method, comprising the acts of:
enabling a business computer system to select at least one program option and provide data for the selected program option;
generating a business directory database having information related to a plurality of businesses located within the geographical region and selected program options and related data via a directory computer system; and
enabling a customer computer system to access the business directory database.

10. The interactive community oriented business directory method of claim 9, comprising the act of enabling the customer computer system to download the business directory database and software executable by the customer computer system to access the business directory database from the directory computer system via the Internet.

11. The interactive community oriented business directory method of claim 9, comprising the act of enabling the customer computer system to access the business directory database via an Internet web page hosted by the directory computer system.

12. The interactive community oriented business directory method of claim 10, comprising the act of enabling the business computer system to communicate with the directory computer system via an Internet web page.

13. The interactive community oriented business directory method of claim 12, wherein the business directory database includes a plurality of business categories and the database is searchable based on the plurality of business categories.

14. The interactive community oriented business directory method of claim 12, comprising the act of enabling the database access software to provide a map window, a search window, and a search results window when executed on the customer computer system.

15. The interactive community oriented business directory method of claim 14, comprising the act of enabling the database access software to maintain an event log table on the customer computer system.

16. The interactive community oriented business directory method of claim 14, comprising the act of enabling a customer computer system user to select one of a category, keyword, and name search type in the search window.

17. A computer readable medium encoded with data instruction for an interactive community oriented business directory method, such that when executed by a device, the device is caused to perform processes comprising:
enabling a business computer system to select at least one program option and provide data for the selected program option;
generating a business directory database having information related to a plurality of businesses located within the geographical region and selected program options and related data via a directory computer system; and
enabling a customer computer system to access the business directory database.

18. The computer readable medium encoded with data instruction for an interactive community oriented business directory method of claim 17, wherein the device is further caused to perform the act of enabling the customer computer system to download the business directory database and software executable by the customer computer system to access the business directory database from the directory computer system via the Internet.

19. The computer readable medium encoded with data instruction for an interactive community oriented business directory method of claim 17, wherein the device is further caused to perform the act of enabling the customer computer system to access the business directory database via an Internet web page hosted by the directory computer system.

20. The computer readable medium encoded with data instruction for an interactive community oriented business directory method of claim 18, wherein the device is further caused to perform the act of enabling the business computer system to communicate with the directory computer system via an Internet web page.

21. The computer readable medium encoded with data instruction for an interactive community oriented business directory method of claim 20, wherein the business directory database includes a plurality of business categories and the database is searchable based on the plurality of business categories.

22. The computer readable medium encoded with data instruction for an interactive community oriented business directory method of claim 20, wherein the device is further caused to perform the act of enabling the database access software to provide a map window, a search window, and a search results window when executed on the customer computer system.

23. The computer readable medium encoded with data instruction for an interactive community oriented business directory method of claim 22, wherein the device is further caused to perform the act of enabling the database access software to maintain an event log table on the customer computer system.

24. The computer readable medium encoded with data instruction for an interactive community oriented business directory method of claim 22, wherein the device is further caused to perform the act of enabling a customer computer system user to select one of a category, keyword, and name search type in the search window.
